(19) United States
(12) Patent Application Publication
(10) Pub. No.: US 2008/0094646 A1
(43) Pub. Date: Apr. 24, 2008

(54) METHOD AND APPARATUS FOR ESTIMATING INK STRIKE-THROUGH IN PRINTING PRESS

(76) Inventors: Ikuo OZAKI, Hiroshima (JP); Shuichi TAKEMOTO, Mihara (JP); Norifumi TASAKA, Mihara (JP)

Correspondence Address: KANESAKA BERNER AND PARTNERS LLP, 1700 DIAGONAL RD, SUITE 310, ALEXANDRIA, VA, 22314-2848, US

(21) Appl. No.: 11/872,018

(22) Filed: Oct. 14, 2007

(30) Foreign Application Priority Data
Jun. 9, 2005 (JP) 2005-170029

(51) Int. Cl. G06F 15/00

(52) U.S. Cl. 358/1.9

(57) ABSTRACT

A method and an apparatus for estimating ink strike-through aims at estimating ink strike-through occurs on a print sheet or web both side of which undergo printing. An apparatus for estimating ink strike-through includes a picture data obtaining section for obtaining a first picture data of a first picture to be printed on the first side and a second picture data of a second picture to be printed on the second side, a database for retaining a corresponding relationship between a difference between the first picture data and the second picture data and a density of strike-through of the ink; and an ink strike-through estimating section for estimating the possible strike-through on the basis of the first picture data and the second picture data obtained by the picture data obtaining section with reference to the database.

### BACKGROUND OF THE INVENTION

1. Field of the Invention

The present invention relates to a method and an apparatus for estimating ink strike-through from one side of a printed sheet, both sides of which undergo printing in a printing press, to the other side of the printed sheet.

2. Description of the Related Art

Patent reference 1 discloses a technique to control the tone value of a picture printed in a printing press. Specifically, a target mixed color density is determined for each of the width-direction segments of the printed sheet, each width-direction segment corresponding to one of the ink supplying units into which an ink supplying device is divided, using printing plate making data obtained from an external entity, and an actual mixed color density of a printed sheet which has undergone printing is measured for each width-direction segment with an IRBG densitometer; these target and actual mixed color halftone densities are converted into tone values and further into monochromatic halftone densities; a solid density difference corresponding to the difference between target and actual monochromatic halftone densities is calculated using a Yule-Nielsen expression or the like; and finally an amount of ink to be supplied is adjusted according to the solid density difference. This technique can realize color tone control using an IRGB densitometer, which is cheaper than a spectrometer.

[Patent Reference 1] Japanese Patent Application Laid-Open (KOKAI) Publication No. 2004-106523

### SUMMARY OF THE INVENTION

In picture tone control carried out in the manner of above Patent Reference 1, as shown in FIG. 8, an IRGB densitometer preferably carries out measurement on a picture printed on a print sheet 8 being wrapped around a guide roll 40 in order to stably obtain an actual mixed color density.

If a print sheet 8 has a light image picture (printed with a relatively small amount of ink) on the front side and a deep image picture (printed with a relatively large amount of ink) on the back side, ink applied to the back side may strike through the front side to make the measurement value of the front side higher than the actual density. In particular, a noticeable ink strike-through occurs in newspaper printing because ink applied to a newspaper page dries by soaking into the page (soaking dry).

For this reason, in the case where ink strike-through occurs on a side of a printed sheet even when the measurement value on a side obtained by IRGB densitometer matches the target density, a picture lighter in color tone than needed (i.e., printed with a smaller amount of ink) is printed on the side because the actual mixed color density is less than the measurement value by a mixed color density of the ink strike-through from the other side to the side in question.

With the foregoing problem in view, the object of the present invention is to provide a method and an apparatus for estimating ink strike-through of a sheet for printing (print sheet) both sides of which undergo printing.

To attain the first above object, as a first generic feature, there is provided a method for estimating possible strike-through of ink from a first side to a second side of a print sheet (or a print web) both sides of which undergo printing in a printing press, comprising the steps of: obtaining a first picture data of a first picture to be printed on the first side and a second picture data of a second picture to be printed on the second side; and estimating the possible strike-through, using a corresponding relationship between a difference between the first picture data and the second picture data and a density of strike-through of the ink, the relationship being previously prepared.

As a second generic feature, there is provided a method for estimating possible strike-through of an ink from a first side to a second side of a print sheet (or a print web) both sides of which undergo printing in a printing press, comprising the steps of: obtaining a picture data of a picture to be printed on the first side; and estimating the possible strike-through, using a corresponding relationship between the picture data and a density of strike-through of the ink, the relationship being previously prepared.

As a third generic feature, there is provided an apparatus for estimating possible strike-through of an ink from a first side to a second side of a print sheet (or a print web) both sides of which undergo printing in a printing press, comprising: a picture data obtaining section for obtaining a first picture data of a first picture to be printed on the first side and a second picture data of a second picture to be printed on the second side; a database for retaining a corresponding relationship between a difference between the first picture data and the second picture data and a density of strike-through of the ink; and an ink strike-through estimating section for estimating the possible strike-through on the basis of the first picture data and the second picture data obtained by the picture data obtaining section with reference to the database.

As a fourth generic feature, there is provided an apparatus for estimating possible strike-through of ink from a first side to a second side of a print sheet (or a print web) both sides of which undergo printing in a printing press, comprising: a picture data obtaining section for obtaining a picture data of a picture to be printed on the first side of the print sheet; a database for retaining a corresponding relationship between the picture data and a density of strike-through of the ink; and an ink strike-through estimating section for estimating the possible strike-through on the basis of the picture data obtained by the picture data obtaining section with reference to the database.

As a preferable feature, either apparatus may further comprise a warning section for warning, if the ink strike-through estimating section estimates occurrence of the possible strike-through, of the occurrence.

It is preferable that the picture data is a tone value data of the picture to be printed.

The methods and apparatuses for estimating ink strike-through in a printing press of the present invention can estimate ink strike-through with reference to a correlation relationship between a tone value of a picture to be printed and a density of ink strike-through, which relationship is previously prepared.

The methods and apparatuses for controlling a color tone in a printing press of the present invention can control a color tone of a picture to be printed factoring in ink strike-through.

Other objects and further features of the present invention will be apparent from the following detailed description when read in conjunction with the accompanying drawings.

### BRIEF DESCRIPTION OF THE DRAWINGS

FIG. 1 is a schematic diagram showing a newspaper offset rotary press according to an embodiment of the present invention;

FIG. 2 is a functional block diagram schematically showing an arithmetic operation apparatus, focusing on functions for estimating ink strike-through and controlling color tone, according to the embodiment;

FIG. 3 is a flow diagram showing a succession of procedural steps performed for controlling color tone according to the embodiment;

FIG. 4 is a flow diagram showing a succession of procedural steps performed for controlling color tone according to the embodiment;

FIG. 5 is a graph showing a correlation between a monochromatic density and a tone value;

FIG. 6 is a graph showing a correlation between a solid density and a monochromatic density;

FIG. 7 is a flow diagram showing a succession of procedural steps carried out to estimate ink strike-through according to the embodiment of the present invention; and

FIG. 8 is a diagram explaining a problem in the prior art.

### DESCRIPTION OF THE PREFERRED EMBODIMENTS

A preferred embodiment of the present invention will now be described with reference to the accompanying drawings.

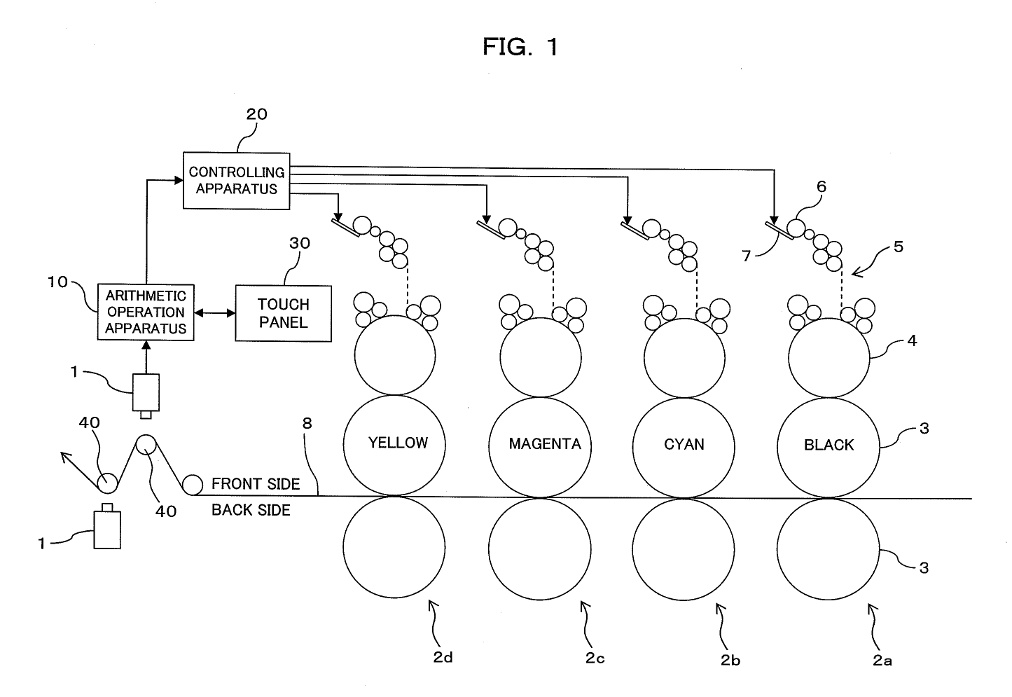

FIG. 1 shows a schematic configuration of a newspaper offset rotary press according to an embodiment of the present invention. The newspaper offset rotary press of the present embodiment is a double-sided printing press for multi-color printing and includes printing units 2a, 2b, 2c and 2d disposed for respective different ink colors [black (k), cyan (c), magenta (m) and yellow (y)] along a transfer path of a print web 8. In the present embodiment, each of the printing units 2a, 2b, 2c and 2d includes an ink supplying apparatus of the ink key type which is formed by a plurality of ink keys 7 and ink fountain rollers 6. In the ink supplying apparatus of the type described, an amount of ink to be supplied can be adjusted by altering a gap between each of the ink keys 7 and the ink fountain roller 6 (the gap amount is herein after referred to as an ink key opening). The ink keys 7 are juxtaposed across the widthwise printing direction, and the ink supplying amount can be adjusted in units of the width of each of the ink keys 7 (a unit width to which each individual ink key 7 supplies ink is herein after referred to as a key zone). The ink, whose supply amount is adjusted by each ink key 7, is kneaded to a suitable degree to form a thin film in an ink roller group 5 and then applied to a printing surface of a printing cylinder 4. Then, the ink applied to the side of a printing plate is transferred as a picture to a blanket cylinder 3 and finally to the print web 8. It is to be noted that, though not shown in FIG. 1, since the newspaper offset rotary press of the present embodiment is for double-sided printing, each of the printing units 2a, 2b, 2c and 2d includes a pair of blanket cylinders 3, 3 interposed by the transfer path of the print web 8, and a printing cylinder 4 and an ink supplying apparatus are provided for each of the blanket cylinders 3.

The newspaper offset rotary press of this embodiment includes a pair of line sensor type IRGB densitometers (simply called IRGB densitometers) 1 on the further downstream of the most downstream printing units 2d. Each line sensor type IRGB densitometer 1 is a measuring instrument for measuring a color of a picture printed on the print web 8 as reflection densities (mixed color halftone densities) of I (infrared light), R (red), G (green) and B (blue) on a line along the printing widthwise direction. Otherwise, the IRGB densitometer 1 can measure the reflection density of the entire print web 8 or measure the reflection density at an arbitrary position of the print web 8. Since the newspaper offset rotary press is for double-sided printing, the line sensor type IRGB densitometers 1 are disposed on the front and the back sides interposed by the transfer path of the printing web 8 so that the densitometers can measure the reflection density on the front and the back sides of the printing web 8.

In the illustrated embodiment, a print web 8 which has undergone printing in printing units 2a, 2b, 2c and 2d is wrapped around two guide rolls 40 and is conveyed to the ensuing step. IRGB densitometers 1 are placed in the proximity of the front and the back sides of the print web 8 being wrapped around the guide rolls 40.

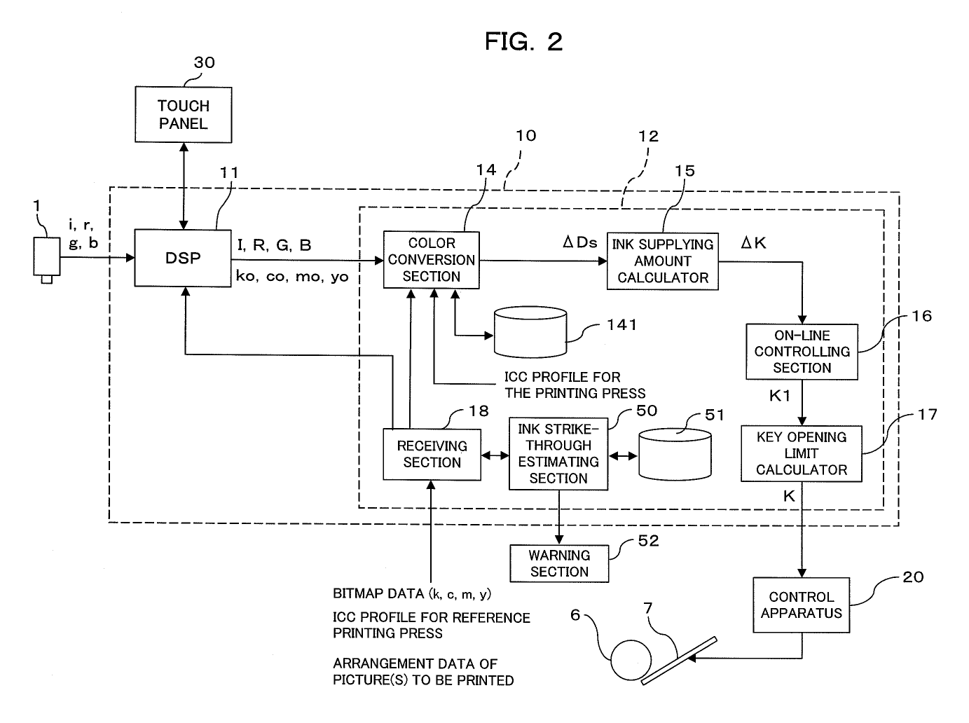

The reflection densities measured by the line sensor type IRGB densitometers 1 are transmitted to an arithmetic operation apparatus 10. The arithmetic operation apparatus 10 calculates control data used for controlling the ink supplying amount, and performs arithmetic operations on the basis of reflection densities measured by the line sensor type IRGB densitometers 1 to figure out the opening of each of the ink keys 7 for making the color of the picture of the printing web 8 coincide with a target color. Here, FIG. 2 schematically shows a configuration of an ink strike-through estimating apparatus and a color tone controlling apparatus for the newspaper offset rotary press according to the embodiment of the present invention and simultaneously is a functional block diagram focusing on functions for estimating ink strike-through and for controlling color tone of the arithmetic operation apparatus 10.

The arithmetic operation apparatus 10 includes a DSP (Digital Signal Processor; corresponding to functions as a focal pixel setting section, a tone value calculating section, and an actual mixed color density measuring section) 11 and a personal computer (PC) 12 which are disposed separately from the printing press. The PC 12 has functions as a color conversion section 14 (corresponding to functions as a target color density setting section, a target tone value calculating section, a target monochromatic density calculating section, an actual tone value calculating section, an actual monochromatic density calculating section, and a solid density difference calculating section), an ink supplying amount calculator 15, an online control section 16, a key opening limit calculator 17, a receiving section 18, and an ink strike-through estimating section 50.

The line sensor type IRGB densitometers 1 are connected to the input side of the arithmetic operation apparatus 10, and a control apparatus 20 incorporated in the printing press is connected to the output side of the arithmetic operation apparatus 10. The control apparatus 20 functions as an ink supplying amount adjusting section for adjusting an amount of an ink that is to be supplied to each of the key zones defined by individual ink keys 7, and controls a non-illustrated opening/closing device for opening and closing the ink keys 7 so that the opening of each key in printing units 2a, 2b, 2c and 2d can be independently adjusted. Further, a touch panel 30 (having a function as an input device) serving as a display is connected to the arithmetic operation apparatus 10.

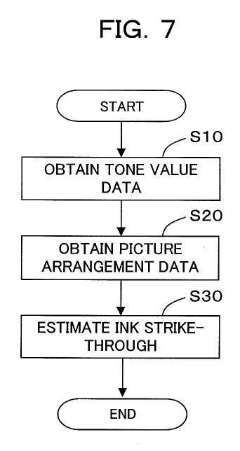

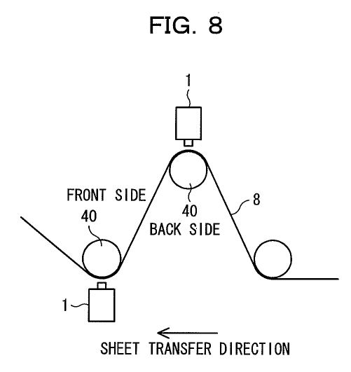

FIG. 7 is a flow diagram showing a succession of procedural steps that arithmetic operation apparatus 10 carries out to estimate ink strike-through. Hereinafter, description is made in relation to a process to estimate ink strike-through with reference mainly to flow diagram 7.

As described above, if a print web 8 has a light image picture (a picture printed with a relatively small amount of ink) on the front side and a deep image picture (a picture printed with a relatively large amount of ink) on the back side, the picture printed on the reverse-side of the print web 8 appears on the front (i.e., ink strike-through occurs). Occurrence of such ink strike-through may cause a failure in accurate color tone control. In other words, if occurrence of ink strike-through can be estimated, it is possible to accurately control a color tone by factoring in the result of the ink strike-through estimate. For this reason, the newspaper offset rotary press of this embodiment is equipped with an ink strike-through estimating apparatus for estimating whether or not ink strike-through occurs on a print web 8 which apparatus is one of the characteristics of the present invention.

The estimating apparatus includes, as main parts, the receiving section 18, the ink strike-through estimating section 50, and a database 51 of the arithmetic operation apparatus 10 and a warning section 52. As shown in FIG. 7, receiving section 18 firstly receives newspaper print data (i.e., kcmy tone value data of pictures to be printed as picture data, also simply called tone value data of pictures to be printed) from an external entity (e.g., a printing request source for a print firm or a newspaper headquarters for a newspaper printing site) via a storing medium or through a wired- or wireless-network in step S10, and further receives picture arrangement data (i.e., arrangement data of the pictures to be printed) for newspaper pages in the ensuing step S20. In the illustrated example, picture arrangement data of pictures to be printed is received after the receipt of tone value data of the same pictures, but alternatively, the picture arrangement data may be received before or at the same time as receipt of the tone value data of the pictures. The newspaper print data sent from a newspaper headquarters is assumed to be in the form of bitmap data (1 bit-Tiff plate making data).

The tone value data of pictures to be printed includes data of tone values of a number of pictures to be printed on both sides of the print web 8. Since, in general newspaper printing, four pages arranged in the width direction are concurrently printed for each side of the print web 8 by the printing units 2a, 2b, 2c, and 2d, tone value data of pictures to be printed concerns pictures that are to be printed on eight pages-four on the front side and four on the back side.

The arrangement data of pictures indicates which picture is to be printed at which width-direction position on the front or the back side of the print web 8 and the like. Assuming that the above tone value data contains data for a total of eight pictures each of which is to be printed one of eight pages of four on the front side and four on the back side, the corresponding arrangement data includes data indicating which of the eight pictures is to be printed at which width-direction position on the front or the back side of the print web 8.

From such tone value data and arrangement data concerning pictures to be printed, it is possible to obtain the tone value of a picture to be printed on a front side of the print web 8 and that of a picture to be printed on the opposite back side. The step of obtaining a tone value corresponds to the steps S10 and S20 in FIG. 7 in the present invention.

Next, ink strike-through estimating section 50 estimates whether or not ink strike-through occurs by using the difference of tone value of a picture to be printed on the back side and that of a picture to be printed on the reverse front side at step S30 (a step of estimating ink strike-through). The database 51 retains a corresponding relationship between the difference of tone values of pictures to be printed on the front and the back side and a density (a mixed color density) of ink strike-through beforehand. The ink strike-through estimating section 50 obtains a density of ink strike-through with reference to the corresponding relationship and thereby estimates occurrence of ink strike-through. The corresponding relationship can be previously prepared considering the results of experiments and simulations.

Specifically, the ink strike-through estimating section 50 calculates, for example, the difference between a tone value of a pixel on a front side of a print web 8 and that of the opposite pixel of the back side. The calculation is performed on all the pixels of pictures to be printed on the front and the back side and calculates a density of ink strike-through of each pixel with reference to the corresponding relationship retained in the database 51.

If a calculated density of ink strike-through of a pixel is larger than zero or a threshold value previously determined, ink strike-through estimating section 50 judges that ink strike-through occurs at the pixel and activates the warning section 52 to warn the operator against the occurrence of the ink strike-through. The warning makes it possible for the operator to grasp whether or not ink strike-through will occur prior to the actual printing process and consequently he or she may turns off the color tone control on a key zone corresponding to the pixel of the ink strike-through. In this case, the opening of the ink key of the key zone is manually adjusted.

Alternatively, the warning by the warning section 52 may be issued only to induce the operator's notice, and as described below, even if the ink strike-through estimating section 50 judges occurrence of ink strike-through, color tone control may be carried out factoring in the ink strike-through without turning off the color tone control, which makes is possible to perform automatic overall color tone adjustment even if ink strike-through occurs.

Further alternatively, a warning may be issued to the operator via the touch panel 30 serving as a substitute for the warning section 52. In this case, the touch panel 30 preferably displays a pixel at which the ink strike-through occurs thereon.

In the present embodiment, estimate of ink strike-through from the back side to the front side of a print web 8 is based on the difference in tone values of pictures to be printed on the front and the back side of the print web 8. As a simple alternative, ink strike-through may be estimated on the only basis of the tone value of a picture to be printed on the back side of the print web 8. In this case, database 51 retains a corresponding relationship between a tone value of a picture to be printed on the back side and a density of ink strike-through in correlation with each other in advance, and a density of the ink strike-through for each pixel is calculated using the relationship. From the result of the calculation, occurrence of ink strike-through is estimated. This relationship can also be prepared considering the results of experiments and simulations.

The above description concerns ink strike-through from the back side to the front side, but ink strike-through from the front side to the back side can be estimated in the same manner.

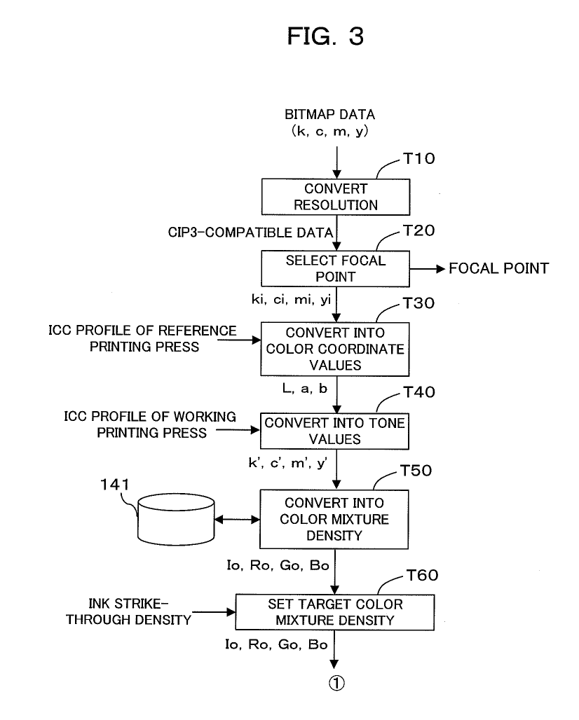

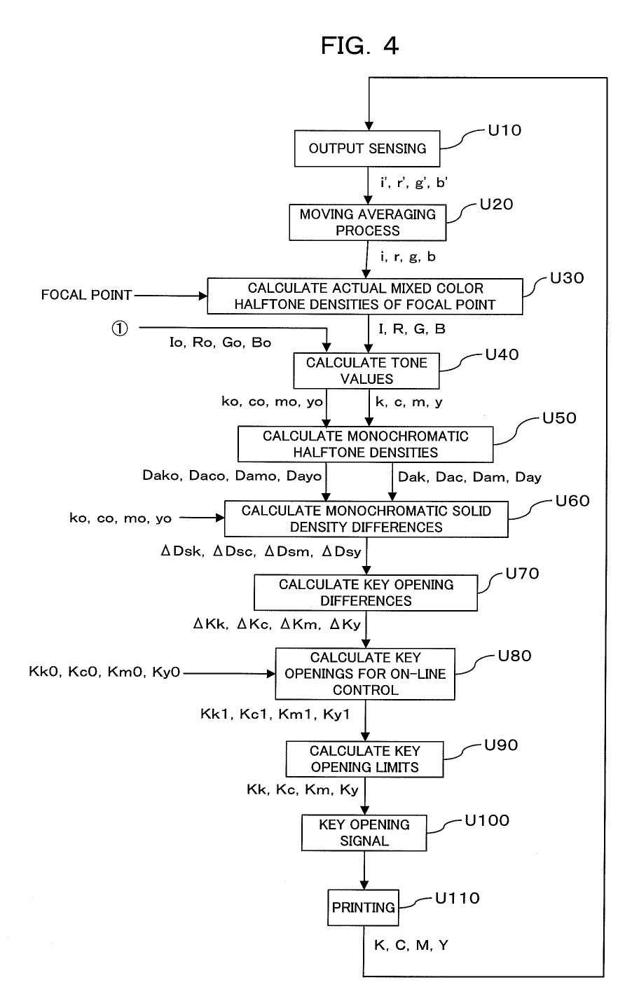

FIGS. 3 and 4 show a succession of procedural steps performed in order to control the color tone in the arithmetic operation apparatus 10.

The color tone control performed by arithmetic operation apparatus 10 will now be described with reference mainly to FIGS. 3 and 4. Here, if ink strike-through estimating section 50 judges occurrence of ink strike-through, color tone control is not turned off, but is carried out according to the ink strike-through.

For the purpose of color tone control of the present invention, the receiving section 18 receives newspaper print data (kcmy tone value data of pictures to be printed) that is described above and ICC (International Color Consortium) profile (herein after called ICC profile of a reference printing press) of an input device which has created color data of the newspaper pages from an external entity via a recording medium or a wired- or wireless-network. As described above, newspaper print data is assumed to be in the form of bitmap data (1 bit-Tiff printing plate making data) and be sent from the newspaper headquarters to the newspaper print site. The ICC profile is a conversion table defining a correlation between a tone value and the color coordinate of the reference printing press which determines the reference color tone of the printing.

First of all, the DSP 11 converts the bitmap data received in the receiving section 18 to low-resolution CIP3-compatible data which conforms to the format of the printing press and which is regarded as tone value data in step T10. The resolution conversion is carried out to share CIP3-compatible data commonly used, but the bitmap data itself can be used as tone value data in the later process. To the DSP 11 is connected the touch panel 30 on which newspaper page image is displayed according to the bitmap data received by receiving section 18.

In step T20, a particular focal point (focal area) is assigned for each ink color within an area of each key zone directly by hand or a touch pen with reference to the newspaper page image displayed on the touch panel 30. A focal point is assigned by arbitrarily selecting a particular point of a newspaper page image displayed on the touch panel 30, and is input to the DSP 11 of the arithmetic operation apparatus 10. A focal point is a position of a picture the colors at which need to coincide with those printed by the reference printing press, and maybe a single pixel, a group of contiguous pixels or all the pixels in each key zone. For a key zone for which the operator does not determine a focal point, DSP 11 automatically determines a focal point. The automatic determination is performed by, for each ink color, calculating the autocorrelation with a tone value of each pixel and automatically extracting a pixel having the maximum autocorrelation to set the extracted pixel as the focal point. For example, the autocorrelation sensitivity Hc of cyan can be represented by “Hc=c²/(k+c+m+y)” using tone value data (k, c, m, y), and a pixel having the maximum automatic sensitivity Hc is assigned as the focal point of ink color cyan. In the same manner, for each of the other ink colors, a pixel having the maximum autocorrelation sensitivity is extracted with reference to the result of the calculation and is assigned as a focal point of the ink color. Alternatively, the DSP 11 may automatically determine a focal point for an ink color which does not exist or having a small picture area within the picture area determined by the operator, for example.

If a focal point for a single key zone is a group of contiguous pixels or all the pixels of the key zone, the DSP 11 regards the average of parameters of the pixels as the corresponding parameter of the focal point. Alternatively, in response to the operator's selection for an arbitrary pixel or to automatic selection for a pixel having the maximum autocorrelation sensitivity, the DSP 11 may assign a pixel group including the selected pixel and contiguous pixels as a focal point and may regard an average of the tone values of the pixels included in the pixel group as that of the focal point. In this case, the pixel quantity and the arrangement of each pixel group with respect to a selected pixel (or automatically extracted pixel) may be determined in the same pattern (e.g., a pixel group is formed by a selected pixel and the eight pixels surrounding the selected pixel), but are preferably determined, considering the position of the selected pixel in the picture and others, such that the effects of disturbance are reduced. Thereby, fluctuation in measurement data is decreased which fluctuation is caused by meandering of the print web 8 or a gap in the longitudinal direction, and thereby can realize stable feedback control.

In the ensuing step T30, the color conversion section 14 converts tone values ki, ci, mi, and yi of a focal point input from the DSP 11 into color coordinate values L, a and b using the ICC profile of the reference printing press sent from the newspaper headquarters. After the conversion in the step T4, a set of the color coordinate values L, a and b is further converted into tone values k′, c′, m′ and y′ using the ICC profile of a printing press in question, which profile is a conversion table in which a tone value for the printing press that is to perform the current printing is correlated with a color coordinate value of the same printing press. Use of the ICC profile of the reference printing press and that of the printing press that is the control object makes it possible to obtain tone values to be used in printing by the printing press in question from the tone values of a picture that is to be printed.

Further, the color conversion section 14 converts the tone values k′, c′, m′ and y′ of the focal point into mixed color halftone densities Io, Ro, Go and Bo with reference to a conversion table stored in a database 141 in step T50, and sets the converted halftone densities to be target color halftone densities Io, Ro, Go and Bo in step T60. The database 141 correlates a tone value of each ink color with mixed color density and is incorporated in the color conversion section 14 of the PC 12. The database 141 is created according to data [conversion table which defines a correlation among tone values (k, c, m, y), mixed color halftone densities (I, R, G, B), and color coordinate values (L, a, b) of the reference colors] obtained by actual measurement on a printed matter under the newspaper printing Japan Color standard established by the ISO/TC130 national commission with a line sensor type IRGB densitometer 1. The use of target mixed color halftone densities Io, Ro, Go and Bo thus set makes the printing press in question print pictures same in color tone as the reference printing press.

At this time, if the ink strike-through estimating section 50 estimates occurrence of ink strike-through at the focal point, the color conversion section 14 sets the target mixed color halftone densities Io, Ro, Go and Bo higher according to the density of the ink strike-through (specifically, the amount of density set higher is identical to that of the density of the ink strike-through). Such color tone control based on mixed color halftone densities thus set can eliminate conventional printing of light-color pictures (with insufficient ink) caused by ink strike-through.

After setting of the target mixed color halftone densities Io, Ro, Go and Bo in the above manner, the printing process is started and a succession of procedural steps after the step U10 in flow diagram FIG. 4 are repetitively performed. First, in step U10, each line sensor type IRGB densitometer 1 measures amounts i′, r′, g′, b′ of light reflected on each of the pixels on the entire surface of the print web 8. The reflected light amounts i′, r′, g′, b′ on the pixels measured by the IRGB densitometer 1 are inputted to the DSP 11. Here, since the print web 8 is blank at the beginning of the procedural steps, the line sensor type IRGB densitometer 1 measures reflected light amounts of reflected light on the blank side and inputs the measured reflected light amounts into the DSP 11.

The DSP 11 performs moving averaging on the reflected light amounts i′, r′, g′ and b′ on each pixel in a unit of a predetermined number of prints to calculate reflected light amounts i, r, g, b on the pixel from which noise components are removed in step U20. In step U30, the reflected light amounts i, r, g, b on pixels assigned as the focal point for each key zone are averaged to calculate color mixed halftone densities (actual mixed color halftone densities) I, R, G, and B with respect to a reflected light amount on a blank portion regarded as a reference. For example, assuming that the reflected light amount of infrared light on a blank portion is represented by ip and an average reflected light amount of the infrared light on each key zone is represented by ik, the actual mixed color density I of the infrared light can be determined from I=log₁₀(ip/ik). The mixed color halftone densities I, R. G, and B of a focal point of each key zone obtained by a calculation in the DSP 11 are input into the color conversion section 14 of the PC 12.

The color conversion section 14 performs the procedural steps U40, U50 and U60. First, a tone value of each ink color corresponding to the actual mixed color halftone densities I, R, G, B set in step U30 are calculated individually in step U40. The database 141 is used for the calculation, and the tone value of each ink color corresponding to the actual mixed color halftone densities I, R, G, B are calculated as actual tone values k, c, m, y with reference to the correlation retained in the database 141. In addition, on the basis of the correlation retained in the database 141, the color conversion section 14 calculates a tone value of each ink color corresponding to the target mixed color halftone densities Io, Ro, Go and Bo set in step T60 shown in FIG. 3 and regards the calculated tone values as target tone values ko, co, mo and yo.

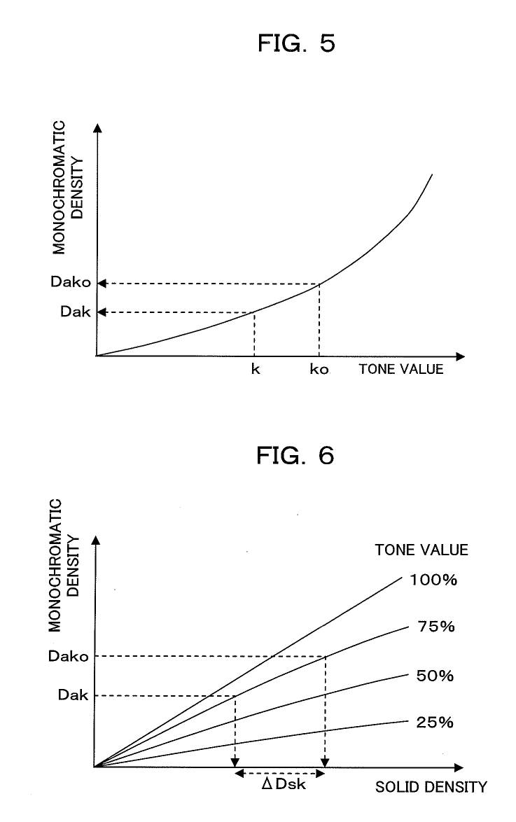

Next, in the step 50, the color conversion section 14 calculates target monochromatic halftone densities of ink colors each corresponding to one of the target tone value ko, co, mo and yo, and calculates actual monochromatic halftone densities of ink colors each corresponding to one of actual tone values k, c, m and y. These calculations use a map shown in FIG. 5, which is an example of a characteristic curve plotting monochromatic density measured as the change in tone value and is created on the basis of data previously measured. The map used in the illustrated example indicates that a rate of increase in monochromatic density increases in accordance with increase in tone value. In the example shown in FIG. 5, collation of a target tone value ko and an actual tone value k for black ink color with the plot on the map can obtain a target monochromatic density Dako and an actual monochromatic density Dak from the characteristic curve on the map. In this manner, the color conversion section 14 obtains target monochromatic halftone densities Dako, Daco, Damo, Dayo and actual monochromatic halftone densities Dak, Dac, Dam, Day of the individual ink colors.

In the next step U60, the color conversion section 14 calculates solid density differences ΔDsk, ΔDsc, ΔDsm, ΔDsy of the individual ink colors corresponding to differences between the target monochromatic halftone densities Dako, Daco, Damo, Dayo and the actual monochromatic halftone densities Dak, Dac, Dam, Day, respectively. A solid density depends also on a tone value, and, with regard to a monochromatic density, a solid density decreases as the tone value increases. For this reason, the color conversion section 14 performs calculation using such a map as shown in FIG. 6, which is an example of a characteristic curve plotting a monochromatic density for each tone value which density is obtained as a result of previous measurement in which the monochromatic solid density is varied. The map used in the illustrated example indicates a monochromatic density for each tone value linearly or substantial-linearly increasing in accordance with increase in a solid density. The color conversion section 14 selects characteristic curve corresponding to the respective target tone values ko, co, mo, yo of the ink colors from within the plots shown in FIG. 6, and determines the solid density differences ΔDsk, ΔDsc, ΔDsm, ΔDsy by applying the target monochromatic halftone densities Dako, Daco, Damo, Dayo and the actual monochromatic halftone densities Dak, Dac, Dam, Day to the selected characteristic curves. In the example shown in FIG. 6, if the target monochromatic density Dako and the actual monochromatic density Dak are applied to the target tone value ko of 75% for black ink color, then the solid density difference ΔDsk of black is determined from within the 75% characteristic curve on the map.

The solid density differences ΔDsk, ΔDsc, ΔDsm, ΔDsy of the individual ink colors calculated by the color conversion section 14 are inputted to the ink supplying amount calculator 15. In step U70, the ink supplying amount calculator 15 calculates key opening difference amounts ΔKk, ΔKc, ΔKm, ΔKy corresponding to the solid density differences ΔDsk, ΔDsc, ΔDsm, ΔDsy, respectively. The key opening difference amounts ΔKk, ΔKc, ΔKm, ΔKy are increasing or decreasing amounts from the current key openings Kk0, Kc0, Km0, Ky0 (i.e., key openings Kk, Kc, Km, Ky outputted to the control apparatus 20 of the printing press in the process at step U100 of the preceding succession of the procedural steps) of the individual ink keys 7, and the ink supplying amount calculator 15 performs the arithmetic operation using the API function (auto-preset inking function) already known to the public. The API function indicates a correlation between tone values (k, c, m, y) of each key zone and key openings K (Kk, Kc, Km, Ky) for the key zone, which correlation is used to obtain a reference density. The tone values can be derived from the bitmap data sent from the newspaper headquarters. Specifically, the supplying amount calculator 15 calculates the ratios kd (kd=ΔDs/Ds) of the solid density differences ΔDs (ΔDsk, ΔDsc, ΔDsm, ΔDsy) to reference densities Ds (Dsk, Dsc, Dsm, Dsy) and the key opening K for obtaining a reference density with respect to each tone value using the API function. Then, ink supplying amount calculator 15 calculates the product of the ratio kd and the key opening K which product serves as an amount ΔK (ΔK=kd×K) of key opening difference for reducing the solid density differences ΔDs to zero.

Then, in step U80, the online control section 16 corrects the key opening difference amounts ΔKk, ΔKc, ΔKm, ΔKy calculated by the color conversion section 14 taking the times for transporting from the printing units 2a, 2b, 2c and 2d to the line sensor type IRGB densitometer 1, reaction times of the ink keys 7 per unit time and the printing speed into consideration. This correction factors in a time delay between input of a key opening signal which prompts an ink key 7 to change the key opening and to thereby change an amount of an ink to be applied to the print web and detection of a change in the reflected light amount by the line sensor type IRGB densitometer 1. Such an online feedback control system which involves considerable dead time as described above is optimally realized by, for example, PI control with dead time compensation, fuzzy control or robust control. The online control section 16 inputs online control key openings Kk1, Kc1, Km1, Ky1, which are obtained by adding the corrected key opening difference amounts (key opening differences for online control) ΔKk, ΔKc, ΔKm, ΔKy to the current key openings for online control Kk0, Kc0, Km0, Ky0, to the key opening limit calculator 17.

In step U90, the key opening limit calculator 17 performs correction of restricting the upper limit values to the key openings Kk1, Kc1, Km1, Ky1 for online control calculated by the online control section 16. This process aims at restricting an abnormal increase in key opening due to an estimation error in the color conversion algorithm (processes performed in steps U40, U50 and U60) performed particularly on a light image picture. The key opening limit calculator 17 sends the key openings Kk, Kc, Km, and Ky, the upper limit values of which are restricted as key opening signals, to the control apparatus 20 of the printing press in step U100.

In step U110, the control apparatus 20 of the printing press adjusts the openings of the ink keys 7 of the printing units 2a, 2b, 2c and 2d on the basis of the key openings Kk, Kc, Km, Ky received from the arithmetic operation apparatus 10. Consequently, the ink supplying amounts of the individual ink colors are controlled so as to conform to a target color tone for each key zone.

As described above, the method and the apparatus for controlling a color tone of the present invention can realize color-tone control considering ink strike-through. Since the present invention controls the color tone using kcmy tone value data of pictures to be printed and an ICC profile of the reference printing press which are obtained from a printing requesting source or the like and an ICC profile of the printing press that is to perform printing of the pictures, the color tone can be adjusted accurately and easily to that desired by the printing requesting source or the like immediately after the start of the printing process, i.e., prior to obtaining an OK web (OK sheet). Accordingly, the amount of paper loss before an OK sheet is obtained can be reduced significantly.

Further, the present invention should by no means be limited to the foregoing embodiment, and various changes or modifications may be suggested without departing from the gist of the invention.

For example, for a key zone at which ink strike-through is estimated to occur, the target mixed color density for the same key zone is set to be higher according to the density of the ink strike-through. Alternatively, color tone control may be realized by adjusting an amount of ink applied in a key zone except a key zone at which ink strike-through is estimated to occur. In this case, color tone for the key zones at which ink strike-through is estimated to occur is turned off and an amount of ink to be supplied to the key zone is adjusted by hand.

As an alteration to the database 141 which correlates a tone value for each ink color with a mixed color density, the publicly known Neugebauer expression that defines the correlation between a tone value for each ink color and a mixed color density may be retained in advance and a mixture density may be calculated by application of a tone value of each ink color to the Neugebauer expression.

In addition, as an alternative to a manner for obtaining a solid density difference of each ink color which difference corresponds to a difference between a target monochromatic density and an actual monochromatic density with reference to a map exemplified by FIG. 6, a publicly known Yule-Nielsen expression which defines the correlation among a tone value, a monochromatic density and a solid density and a solid density may be calculated by applying a target tone value, an actual tone value and a monochromatic density to the expression.

Further, the foregoing embodiment uses the line sensor type IRGB densitometers 1, which may be substituted by spot type IRGB densitometers which scan the side of a print web in two dimensions.

In the absence of ICC profiles of a reference printing press and the printing press that is to perform the actual printing process, the steps T30 and T40 in FIG. 3 are skipped. In this case, tone values ki, ci mi and yi of the focal point obtained in step T20 are, in step T50, converted into mixture halftone densities Io, Ro, Go and Bo with reference to the conversion table stored in the database 141, which densities are set to be the target mixed color densities Io, Ro, Go and Bo in the ensuing step T60.

What is claimed is:

1. A method for estimating strike-through of ink from a first side to a second side of a print sheet or web both sides of which undergo printing in a printing press, comprising the steps of:
obtaining a first picture data of a first picture to be printed on the first side and a second picture data of a second picture to be printed on the second side; and
estimating the strike-through, using a corresponding relationship between a difference between the first picture data and the second picture data and a density of strike-through of the ink, the relationship being previously prepared.

2. A method for estimating strike-through of ink from a first side to a second side of a print sheet or web both sides of which undergo printing in a printing press, comprising the steps of:
obtaining a picture data of a picture to be printed on the first side; and
estimating the strike-through, using a corresponding relationship between the picture data and a density of strike-through of the ink, the relationship being previously prepared.

3. A method for estimating strike-through of ink according to claim 1, wherein
the picture data is a tone value data of the picture to be printed.

4. A method for estimating strike-through of ink according to claim 2, wherein
the picture data is a tone value data of the picture to be printed.

5. An apparatus for estimating strike-through of ink from a first side to a second side of a print sheet or web both sides of which undergo printing in a printing press, comprising:
a picture data obtaining section for obtaining a first picture data of a first picture to be printed on the first side and a second picture data of a second picture to be printed on the second side;
a database for retaining a corresponding relationship between a difference between the first picture data and the second picture data and a density of strike-through of the ink; and
an ink strike-through estimating section for estimating the strike-through on the basis of the first picture data and the second picture data obtained by said picture data obtaining section with reference to said database.

6. An apparatus for estimating strike-through of ink from a first side to a second side of a print sheet or web both sides of which undergo printing in a printing press, comprising:
a picture data obtaining section for obtaining a picture data of a picture to be printed on the first side of the print sheet or web;
a database for retaining a corresponding relationship between the picture data and a density of strike-through of the ink; and
an ink strike-through estimating section for estimating the strike-through on the basis of the picture data obtained by said picture data obtaining section with reference to said database.

7. An apparatus for estimating strike-through of ink according to claim 5, wherein
the picture data is a tone value data of the picture to be printed.

8. An apparatus for estimating strike-through of ink according to claim 5, further comprising:
a warning section for warning, if said ink strike-through estimating section estimates occurrence of the strike-through, of the occurrence.

9. An apparatus for estimating strike-through of ink according to claim 7, further comprising:
a warning section for warning, if said ink strike-through estimating section estimates occurrence of the strike-through, of the occurrence.

10. An apparatus for estimating strike-through of ink according to claim 6, wherein
the picture data is a tone value data of the picture to be printed.

11. An apparatus for estimating strike-through of ink according to claim 6, further comprising:
a warning section for warning, if said ink strike-through estimating section estimates occurrence of the strike-through, of the occurrence.

12. An apparatus for estimating strike-through of ink according to claim 10, further comprising:
a warning section for warning, if said ink strike-through estimating section estimates occurrence of the strike-through, of the occurrence.
